(19) United States
(12) Patent Application Publication
(10) Pub. No.: US 2025/0200941 A1
(43) Pub. Date: Jun. 19, 2025

(54) DEVICE AND METHOD FOR RECOGNIZING SKETCH

(71) Applicant: ELECTRONICS AND TELECOMMUNICATIONS RESEARCH INSTITUTE, Daejeon (KR)

(72) Inventor: Min Ho BAE, Daejeon (KR)

(21) Appl. No.: 18/984,640

(22) Filed: Dec. 17, 2024

(30) Foreign Application Priority Data
Dec. 18, 2023 (KR) 10-2023-0184837

(51) Int. Cl. G06V 10/764; G06N 3/0442; G06N 20/20; G06V 10/62; G06V 10/774

(52) U.S. Cl. CPC G06V 10/764; G06N 3/0442; G06N 20/20; G06V 10/62; G06V 10/774

(57) ABSTRACT

Provided are a device and method for recognizing a sketch. The device includes a memory configured to store at least one instruction and a processor configured to execute the at least one instruction stored in the memory. The processor generates a plurality of frames from sketch data about a sketch image created by a user, extracts features from each of the plurality of frames, trains a deep learning model configured to classify a sketch image into a class, on the basis of the extracted features, and performs sketch recognition using the trained deep learning model.

### CROSS-REFERENCE TO RELATED APPLICATION

This application claims priority to and the benefit of Korean Patent Application No. 10-2023-0184837, filed on Dec. 18, 2023, the disclosure of which is incorporated herein by reference in its entirety.

### BACKGROUND

### 1. Field of the Invention

The present invention relates to a device and method for recognizing a sketch.

### 2. Discussion of Related Art

Sketches are convenient and universal communication tools for overcoming language barriers. With the recent increase in the number of touch-enabled electronic devices such as smartphones, tablets, and the like, it has become easier to draw sketches on electronic devices using a finger, an electronic pen, or the like, and accordingly, numerous application programs for sketch scene understanding, sketch-based image searching, and the like are under development.

Meanwhile, sketches are composed of only a small amount of information compared to general images. Therefore, despite the development of vision deep learning technology, sketch recognition is not very accurate, which is problematic.

### SUMMARY OF THE INVENTION

The present invention is directed to providing a device and method for recognizing a sketch on the basis of temporal information and spatial information of a sketch created by a user.

According to an aspect of the present invention, there is provided a device for recognizing a sketch, the device including a memory configured to store at least one instruction and a processor configured to execute the at least one instruction stored in the memory. The processor generates a plurality of frames from sketch data about a sketch image created by a user, extracts features from each of the plurality of frames, trains a deep learning model configured to classify the sketch image into a class, on the basis of the extracted features, and performs sketch recognition using the trained deep learning model.

The sketch data may include stroke data about each of strokes constituting the sketch image, the stroke data may include point data about each of points constituting the strokes, and the point data may include information about position coordinates and generation times of the points.

The processor may generate the plurality of frames by detecting sketch images of time points determined in accordance with a preset criterion.

The processor may calculate a value (A) by dividing a time required for completing the sketch image by a preset value and detect each of sketch images of time points that are A*N (N=1, 2, 3, . . . , and the preset value) after drawing of the sketch image is started, to generate the plurality of frames.

The processor may calculate a value (B) by dividing a total number of strokes constituting the sketch image by a preset value and detect each of sketch images of time points when (B*N)^{th} (N=1, 2, 3, . . . , and the preset value) strokes are completed, to generate the plurality of frames.

The processor may calculate a value (C) by dividing a total number of points constituting the sketch image by a preset value and detect each of sketch images of time points when (C*N)^{th} (N=1, 2, 3, . . . , and the preset value) points are completed, to generate the plurality of frames.

The processor may generate new frames by augmenting the plurality of frames and train the deep learning model on the basis of features extracted from each of the new frames and the features extracted from each of the existing frames.

The processor may augment the frames by performing, on any frame, at least one of an operation of rotating at least one stroke, an operation of changing a generation turn of at least one stroke, an operation of changing a shape of at least one stroke, and an operation of changing a ratio of at least one stroke.

The deep learning model may include a transformer model and an ensemble model, and the processor may train the transformer model, which is configured to produce class possibility data for each frame, on the basis of the extracted features and train the ensemble model, which is configured to produce class possibility data for the sketch image, on the basis of the class possibility data calculated for each frame.

The transformer model may receive the extracted features and perform a plurality of multi-head self-attention processes to learn relationships between the plurality of frames.

The ensemble model may include a plurality of long short-term memory (LSTM) models configured to correspond to the plurality of frames.

The processor may receive target sketch data about a target sketch image, input the target sketch data to the trained deep learning model, acquire class possibility data output from the trained deep learning model, and recognize the target sketch image on the basis of the acquired class possibility data.

According to another aspect of the present invention, there is provided a method of recognizing a sketch, the method including generating a plurality of frames from sketch data about a sketch image created by a user, extracting features from each of the plurality of frames, training a deep learning model configured to classify a sketch image into a class, on the basis of the extracted features, and performing sketch recognition using the trained deep learning model.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram of a device for recognizing a sketch according to an exemplary embodiment of the present invention;

FIG. 2 shows an example of sketch data according to an exemplary embodiment of the present invention;

FIGS. 3A to 3C are set of example diagrams illustrating a frame generation process according to an exemplary embodiment of the present invention;

FIGS. 4A to 4C are set of example diagrams illustrating a frame augmentation process according to an exemplary embodiment of the present invention;

FIG. 5 is an example diagram illustrating a feature extraction process according to an exemplary embodiment of the present invention;

FIG. 6 is an example diagram illustrating a deep learning model training process according to an exemplary embodiment of the present invention;

FIG. 7 is an example diagram illustrating a transformer model training process according to an exemplary embodiment of the present invention;

FIG. 8 is an example diagram illustrating an ensemble model training process according to an exemplary embodiment of the present invention;

FIG. 9 is a flowchart illustrating a deep learning model training process in a method of recognizing a sketch according to an exemplary embodiment of the present invention; and

FIG. 10 is a flowchart illustrating a sketch image recognition process in a method of recognizing a sketch according to an exemplary embodiment of the present invention.

### DETAILED DESCRIPTION OF EXEMPLARY EMBODIMENTS

Hereinafter, a device and method for recognizing a sketch according to exemplary embodiments of the present invention will be described in detail with reference to the accompanying drawings. In this process, the thicknesses of lines, the sizes of components, and the like shown in the drawings may be exaggerated for the purpose of clarity and convenience of description. Also, terms to be described below are defined in consideration of functions in the present invention, and the terms may vary depending on the intention of a user or operator or precedents. Therefore, these terms are to be defined on the basis of the overall content of the specification.

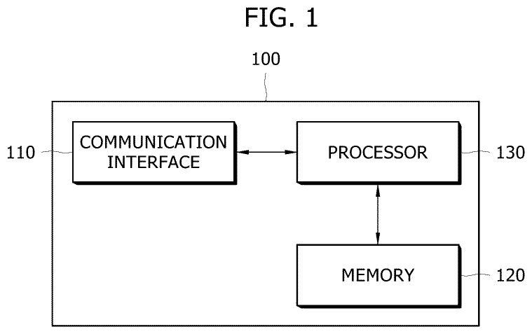

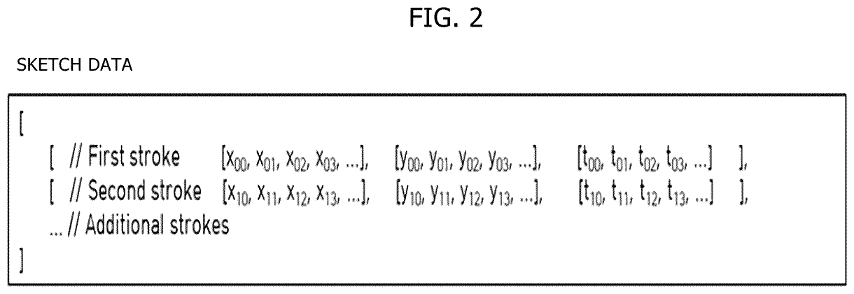

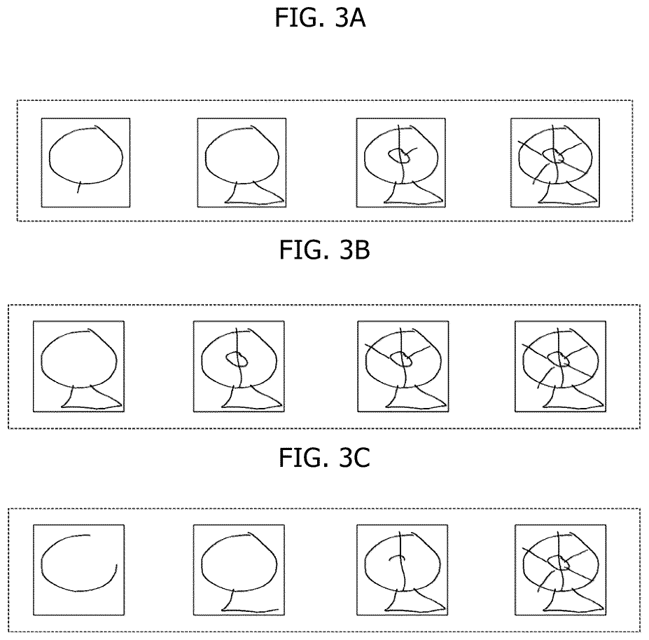

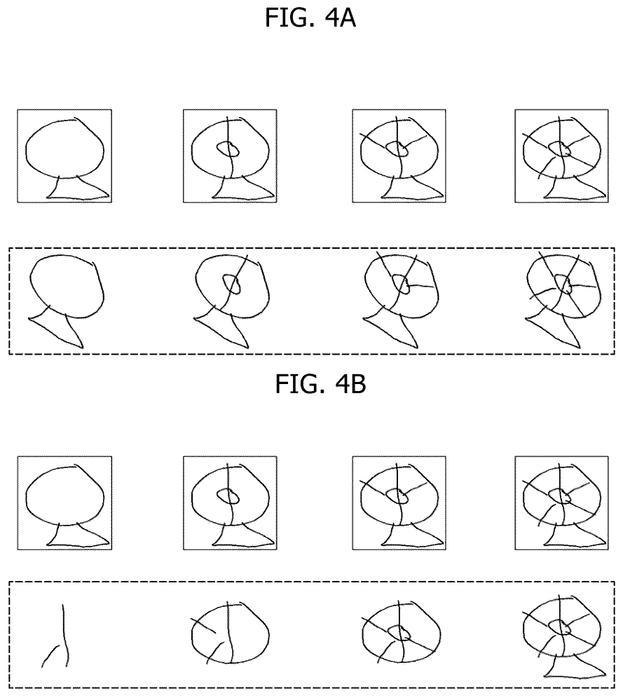

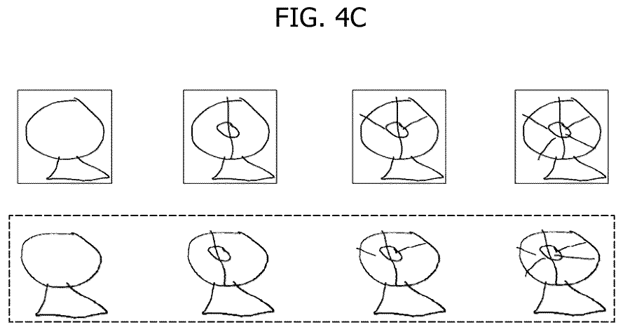

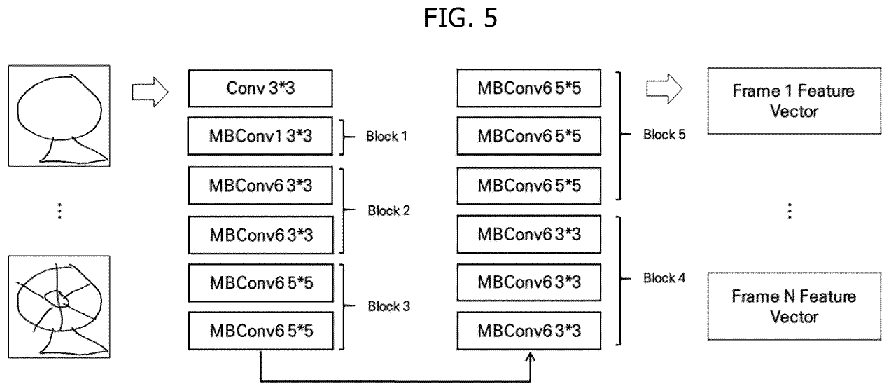

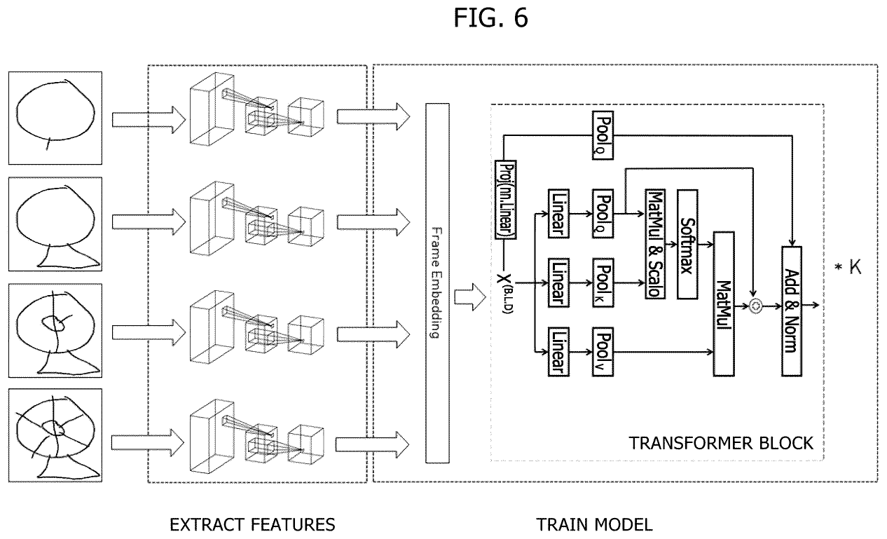

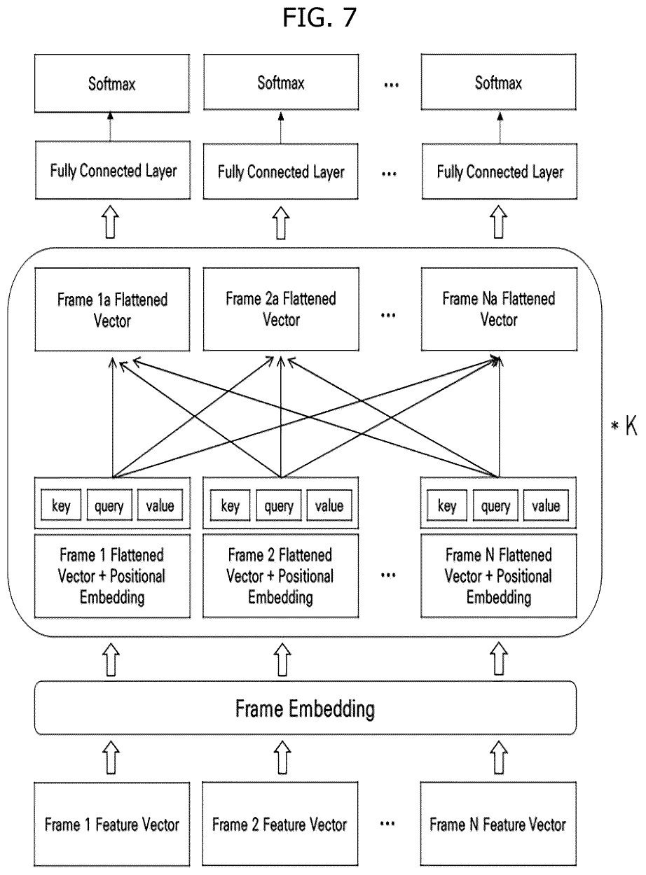

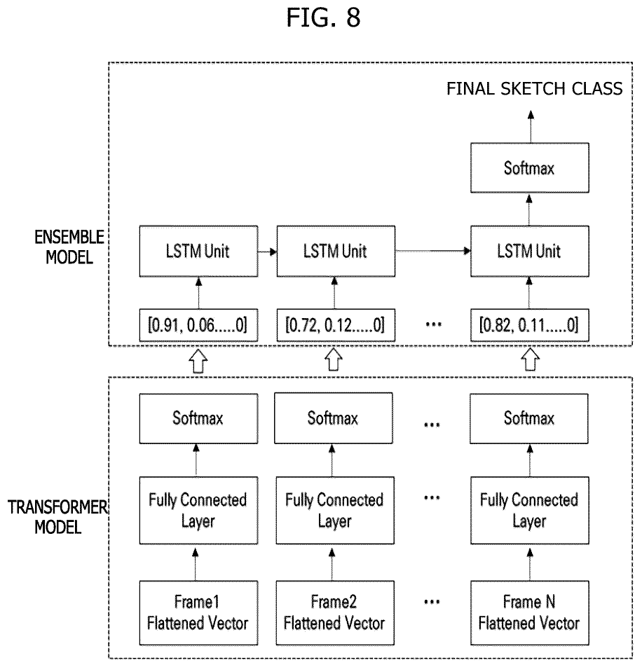

FIG. 1 is a block diagram of a device for recognizing a sketch according to an exemplary embodiment of the present invention, FIG. 2 shows an example of sketch data according to an exemplary embodiment of the present invention, FIGS. 3A to 3C are set of example diagrams illustrating a frame generation process according to an exemplary embodiment of the present invention, FIGS. 4A to 4C are set of example diagrams illustrating a frame augmentation process according to an exemplary embodiment of the present invention, FIG. 5 is an example diagram illustrating a feature extraction process according to an exemplary embodiment of the present invention, FIG. 6 is an example diagram illustrating a deep learning model training process according to an exemplary embodiment of the present invention, FIG. 7 is an example diagram illustrating a transformer model training process according to an exemplary embodiment of the present invention, and FIG. 8 is an example diagram illustrating an ensemble model training process according to an exemplary embodiment of the present invention.

Referring to FIG. 1, a device 100 for recognizing a sketch according to an exemplary embodiment of the present invention may include a communication interface 110, a memory 120, and a processor 130. The device 100 for recognizing a sketch according to an exemplary embodiment of the present invention may further include various components other than the components shown in FIG. 1, or some of the components may be omitted.

The communication interface 110 may communicate with an external device. The communication interface 110 may communicate with various kinds of external devices in accordance with various kinds of communication methods. For example, the communication interface 110 may communicate with an electronic device that may access a sketch creation program to receive a sketch image (sketch data) from the electronic device. The electronic device may include an input interface, such as a mouse, a touchscreen, an electronic pen, or the like, for creating a sketch. For example, the electronic device may be a desktop computer, a tablet computer, a laptop computer, or a smartphone.

The memory 120 may store at least one instruction executed by the processor 130. The memory 120 may be implemented as a volatile storage medium and/or a non-volatile storage medium. For example, the memory 120 may be implemented as a read-only memory (ROM) and/or a random access memory (RAM).

The memory 120 may store various information required for an operation process of the processor 130. The memory 120 may store various information produced in an operating process of the processor 130.

The processor 130 may be implemented as a central processing unit (CPU) or a system on chip (SoC) and may run an operating system (OS) or application to control a plurality of hardware or software components connected to the processor 130 and perform various data processing and computations. The processor 130 may be configured to execute the at least one instruction stored in the memory 120 and store the execution result data in the memory 120.

The processor 130 may generate a plurality of frames from sketch data about a sketch image created by a user. As vector data representing the sketch image created by the user, the sketch data may include stroke data about each stroke constituting the sketch image. As vector data representing strokes generated by the user, the stroke data may include point data about each point constituting the strokes. As data representing points generated by the user, the point data may include information about position coordinates (x-y coordinates) and generation times of the points. The sketch data may be collected and stored in the memory 120 in advance.

For example, referring to the sketch data of FIG. 2, first point data about a first stroke may be [x₀₀, y₀₀, t₀₀], and second point data about the first stroke may be [x₀₁, y₀₁, t₀₁]. Here, xₙₘ may represent an x coordinate of an m^{th} point of an n^{th} stroke, yₙₘ may represent a y coordinate of the m^{th} point of the n^{th} stroke, and tₙm may represent a time when the m^{th} point of the n^{th} stroke is generated, which may mean the time that has elapsed since the initial point (the first point of the first stroke) was generated. t of the initial point, that is, t₀₀, may be 0.

In FIG. 2, stroke data about the first stroke may be {[x₀₀, x₀₁, x₀₂, . . . ], [y₀₀, y₀₁, y₀₂, . . . ], and [t₀₀, t₀₁, t₀₂, . . . ]}, and stroke data about the second stroke may be {[x₁₀, x₁₁, x₁₂, . . . ], [y₁₀, y₁₁, y₁₂, . . . ], and [t₁₀, t₁₁, t₁₂, . . . ]}. In FIG. 2, the sketch data about a sketch image may be [{[x₀₀, x₀₁, x₀₂, . . . ], [y₀₀, y₀₁, y₀₂, . . . ], and [t₀₀, t₀₁, t₀₂, . . . ]}, {[x₁₀, x₁₁, x₁₂, . . . ], [y₁₀, y₁₁, y₁₂, . . . ], and [t₁₀, t₁₁, t₁₂, . . . ]}, . . . ]. Like this, sketch data may be data including temporal information and spatial information about a sketch image.

The processor 130 may generate the plurality of frames by detecting sketch images of time points which are determined in accordance with a preset criterion. A frame may represent a sketch image of any point in time between the start and end of sketch image creation.

The processor 130 may generate the plurality of frames from the sketch data about the sketch image. The processor 130 may calculate a value A by dividing a time required for completing the sketch image by a preset value and detect each of sketch images of time points that are A*N (N=1, 2, 3, . . . , and the preset value) after the drawing of the sketch image is started, to generate the plurality of frames. For example, when the time required for completing the sketch image is 20 seconds and the preset value is four, the processor 130 may detect sketch images of time points that are 5*N (N=1, 2, 3, and 4) after the drawing of the sketch image is started, to generate a plurality of frames as shown in FIG. 3A.

The processor 130 may calculate a value B by dividing a total number of strokes constituting the sketch image by a preset value and detect each of sketch images of time points when (B*N)^{th} (N=1, 2, 3, . . . , and the preset value) strokes are completed, to generate the plurality of frames. For example, when the total number of frames constituting the sketch image is eight and the preset value is four, the processor 130 may detect sketch images of time points when (2*N)^{th} (N=1, 2, 3, and 4) strokes are completed, to generate a plurality of frames as shown in FIG. 3B.

At this time, when B is not an integer, the processor 130 may make B an integer with a ceiling, flooring, rounding, and the like. According to another exemplary embodiment, when B is not an integer, the processor 130 may detect a sketch image of a time point when a stroke following a stroke corresponding to an integer portion of B*N is completed by a ratio of the fractional portion of B*N to the integer portion, and may use the sketch image as a frame.

As shown in FIG. 3C, the processor 130 may calculate a value C by dividing a total number of points constituting the sketch image by a preset value and detect each of sketch images of time points when (C*N)^{th} (N=1, 2, 3, . . . , and the preset value) points are completed, to generate the plurality of frames.

Meanwhile, since sketches are generated with many degrees of freedom, there may be cases where point data does not exist or is very little in a specific time period, resulting in little change between frames. Therefore, according to the present embodiment, when a difference (in the number of points, spatial position, and the like) between an N^{th} frame and an (N−1)^{th} frame is a preset threshold or less, the (N−1)^{th} frame may be replaced with the N^{th} frame, and frame generation may resume from the N^{th} frame. The processor 130 may generate the N^{th} frame to the last frame again using any one of the above-described methods. For example, when the time required for completing the sketch image is 50 seconds and the preset value is ten, the processor 130 may generate frames at intervals of ten seconds to generate five frames in total. Here, when a difference between a third frame and a fourth frame is the threshold or less, the processor 130 may remove the third frame and use the fourth frame as the third frame. Also, the processor 130 may divide ten seconds, which is a remaining time after the fourth frame (i.e., a value calculated by subtracting a time required for completing a sketch image corresponding to the fourth frame from the time required for completing the sketch image) by two, which is the number of frames to be generated again (a value calculated by subtracting the number of already generated frames from the total number of frames), and detect sketch images of a time point that is five seconds after the generation of the fourth frame (i.e., 45 seconds after the creation of the sketch image is started) and a time point that is ten seconds after the generation of the fourth frame (i.e., 50 seconds after the creation of the sketch image is started) to generate a fourth frame and a fifth frame again.

The processor 130 may augment a plurality of frames to generate new frames.

As shown in FIG. 4, the processor 130 may augment frames by performing, on any frame, at least one of an operation of rotating at least one stroke (FIG. 4A), an operation of changing a generation turn of at least one stroke (FIG. 4B), an operation of changing the shape of at least one stroke (FIG. 4C), and an operation of changing a ratio of at least one stroke. The processor 130 may augment frames by randomly performing at least one of the foregoing operations. The processor 130 may generate new frames by repeatedly performing the above-described augmentation operation on each of the plurality of frames.

The processor 130 may extract features (feature vectors) from each of the plurality of frames. The processor 130 may extract features from each of the plurality of frames using a convolutional neural network (CNN) model. For example, the processor 130 may extract a feature from each frame using an EfficientNet B0 model as shown in FIG. 5. However, a method of extracting a feature is not limited to the above-described embodiment, and various CNN algorithms, such as EfficientNet, Resnet-50, and the like, may be utilized to extract features from frames. In some cases, the processor 130 may utilize only a part of a CNN model to extract a feature from a frame. For example, the processor 130 may utilize only five out of seven blocks included in the EfficientNet B0 model to extract a feature from a frame.

The processor 130 may train a deep learning model configured to classify a sketch image into a class, on the basis of the features extracted from each of the plurality of frames. As shown in FIG. 6, the features extracted from each of the plurality of frames may be input to the deep learning model and used for training the deep learning model. The deep learning model configured to classify a sketch image into a class may include a transformer model and an ensemble model.

The processor 130 may train the transformer model configured to produce class possibility data for each frame, on the basis of the features extracted from each of the plurality of frames. As shown in FIG. 7, for each frame, the processor 130 may perform an embedding operation of changing a feature vector to a one-dimensional (1D) vector and a positional encoding operation of adding positional information to the feature vector changed to the 1D vector. Data (a 1D vector and positional information) generated for each frame may be input to the transformer model, and the transformer model may perform a plurality of multi-head self-attention processes to learn relationships between the plurality of frames.

Frame-specific attention values (vector values) calculated through the plurality of multi-head self-attention processes may be converted into class possibility data through a fully connected layer and a softmax function. The class possibility data may include information about the possibility of each class.

Meanwhile, according to the present embodiment, no class token is used, which is unlike a general transformer, and all token results separately generated for frames may be utilized for training through the fully connected layer.

The processor 130 may train the ensemble model configured to produce class possibility data for a sketch image, on the basis of the class possibility data produced for each frame. As shown in FIG. 8, the ensemble model may include a plurality of LSTMs configured to correspond to a plurality of frames. However, the ensemble model is not limited to the foregoing embodiment, and various time-series models (e.g., a recurrent neural network (RNN) and the like) may be used. The class possibility data produced for each frame may be input to each of the LSTMs, and the ensemble model may learn the correlation between the class possibility data produced for each frame and class possibility data for the sketch image. Class possibility data for an N^{th} frame may be input to an N^{th} LSTM, and an output value of the N^{th} frame may be calculated on the basis of an output of an (N−1)^{th} frame and the input class possibility data. An output value of the last LSTM may be converted into class possibility data for the sketch image (sketch data) through the softmax function.

The processor 130 may perform sketch recognition using the deep learning model. The processor 130 may receive target sketch data for a target sketch image, input the received target sketch data to the deep learning model, acquire class possibility data output from the deep learning model, and recognize the target sketch image on the basis of the acquired class possibility data. The processor 130 may detect a class with the highest possibility from the class possibility data and recognize the detected class as a class of the target sketch image.

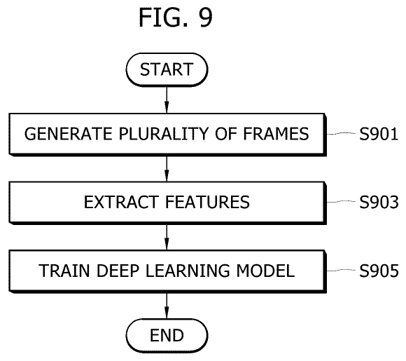

FIG. 9 is a flowchart illustrating a deep learning model training process in a method of recognizing a sketch according to an exemplary embodiment of the present invention.

A process of training a deep learning model for recognizing a sketch will be described below focusing on operations of the processor 130 with reference to FIG. 9. Meanwhile, detailed description of elements overlapping the above description will be omitted, and a time-series configuration thereof will be mainly described below.

First, the processor 130 may generate a plurality of frames from sketch data about a sketch image (S901). The sketch data may be collected in advance through the communication interface 110 and stored in the memory 120. At this time, the processor 130 may generate the plurality of frames by detecting sketch images of time points which are determined in accordance with a preset criterion. In some cases, the processor 130 may additionally generate new frames by augmenting the plurality of frames.

Subsequently, the processor 130 may extract features from each of the plurality of frames (S903). The processor 130 may extract the features from each of the plurality of frames using a CNN.

Subsequently, the processor 130 may train a deep learning model on the basis of the features extracted from each of the plurality of frames (S905). On the basis of the features extracted from each of the plurality of frames, the processor 130 may train a transformer model, which is configured to produce class possibility data for each frame, and train the ensemble model, which is configured to produce class possibility data for the sketch image, on the basis of the class possibility data calculated for each frame.

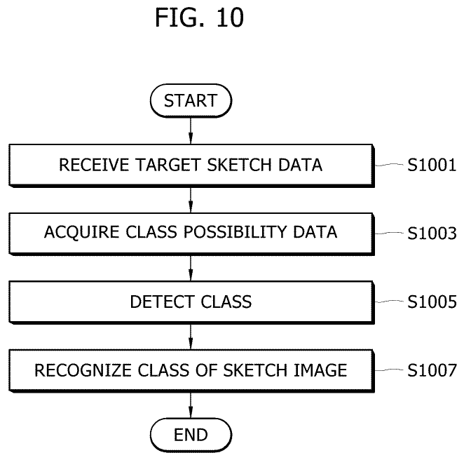

FIG. 10 is a flowchart illustrating a sketch image recognition process in a method of recognizing a sketch according to an exemplary embodiment of the present invention.

A process of recognizing a sketch image using a trained deep learning model will be described below focusing on operations of the processor 130 with reference to FIG. 10. Meanwhile, detailed description of elements overlapping the above description will be omitted, and a time-series configuration thereof will be mainly described below.

First, the processor 130 may receive target sketch data about a target sketch image from the outside of the device 100 (e.g., an electronic device) through the communication interface 110 (S1001).

Subsequently, the processor 130 may acquire class possibility data by inputting the target sketch data to the deep learning model (S1003). When the target sketch data is input, the deep learning model may output class possibility data about the target sketch data.

Subsequently, the processor 130 may detect a class with the highest possibility from the class possibility data (S1005) and recognize the detected class as a class of the target sketch image (S1007).

A device and method for recognizing a sketch according to exemplary embodiments of the present invention can accurately recognize a sketch on the basis of temporal information and spatial information about a sketch generated by a user.

Effects of the present invention are not limited to that described above, and other effects that have not been described will be clearly understood by those of ordinary skill in the art.

Description of this specification may be implemented using, for example, a method or process, a device, a software program, a data stream, or a signal. Even if a feature is discussed only in a single form of implementation (e.g., discussed only as a method), the discussed feature may be implemented in another form (e.g., a device or program). The device may be implemented as appropriate hardware, software, firmware, and the like. The method may be implemented in a device such as a processor which generally refers to a processing device including, for example, a computer, a microprocessor, an integrated circuit, a programmable logic device, or the like. The processor may also include a computer, a cellular phone, a personal digital assistant (PDA), and other communication devices facilitating information communication between end users.

Although the present invention has been described above with reference to embodiments illustrated in the drawings, the embodiments are merely illustrative, and those skilled in the art should understand that various modifications and other equivalent embodiments can be made from the embodiments. Therefore, the technical scope of the present invention should be determined from the following claims.

What is claimed is:

1. A device for recognizing a sketch, the device comprising:
a memory configured to store at least one instruction; and
a processor configured to execute the at least one instruction stored in the memory,
wherein the processor generates a plurality of frames from sketch data about a sketch image created by a user, extracts features from each of the plurality of frames, trains a deep learning model configured to classify the sketch image into a class, on the basis of the extracted features, and performs sketch recognition using the trained deep learning model.

2. The device of claim 1, wherein the sketch data includes stroke data about each of strokes constituting the sketch image,
the stroke data includes point data about each of points constituting the strokes, and
the point data includes information about position coordinates and generation times of the points.

3. The device of claim 1, wherein the processor generates the plurality of frames by detecting sketch images of time points determined in accordance with a preset criterion.

4. The device of claim 3, wherein the processor calculates a value (A) by dividing a time required for completing the sketch image by a preset value and detects each of sketch images of time points that are A*N (N=1, 2, 3, . . . , and the preset value) after drawing of the sketch image is started, to generate the plurality of frames.

5. The device of claim 3, wherein the processor calculates a value (B) by dividing a total number of strokes constituting the sketch image by a preset value and detects each of sketch images of time points when (B*N)^{th} (N=1, 2, 3, . . . , and the preset value) strokes are completed, to generate the plurality of frames.

6. The device of claim 3, wherein the processor calculates a value (C) by dividing a total number of points constituting the sketch image by a preset value and detects each of sketch images of time points when (C*N)^{th} (N=1, 2, 3, . . . , and the preset value) points are completed, to generate the plurality of frames.

7. The device of claim 1, wherein the processor generates new frames by augmenting the plurality of frames and trains the deep learning model on the basis of features extracted from each of the new frames and the features extracted from each of the existing frames.

8. The device of claim 7, wherein the processor augments the frames by performing, on any frame, at least one of an operation of rotating at least one stroke, an operation of changing a generation turn of at least one stroke, an operation of changing a shape of at least one stroke, and an operation of changing a ratio of at least one stroke.

9. The device of claim 1, wherein the deep learning model includes a transformer model and an ensemble model, and
the processor trains the transformer model, which is configured to produce class possibility data for each frame, on the basis of the extracted features and trains the ensemble model, which is configured to produce class possibility data for the sketch image, on the basis of the class possibility data calculated for each frame.

10. The device of claim 9, wherein the transformer model receives the extracted features and performs a plurality of multi-head self-attention processes to learn relationships between the plurality of frames.

11. The device of claim 9, wherein the ensemble model includes a plurality of long short-term memory (LSTM) models configured to correspond to the plurality of frames.

12. The device of claim 1, wherein the processor receives target sketch data about a target sketch image, inputs the target sketch data to the trained deep learning model, acquires class possibility data output from the trained deep learning model, and recognizes the target sketch image on the basis of the acquired class possibility data.

13. A method of recognizing a sketch performed by a computing device including a processor, the method comprising:
generating a plurality of frames from sketch data about a sketch image created by a user;
extracting features from each of the plurality of frames;
training a deep learning model configured to classify the sketch image into a class, on the basis of the extracted features; and
performing sketch recognition using the trained deep learning model.

14. The method of claim 13, wherein the sketch data includes stroke data about each of strokes constituting the sketch image,
the stroke data includes point data about each of points constituting the strokes, and
the point data includes information about position coordinates and generation times of the points.

15. The method of claim 13, wherein the generating of the plurality of frames comprises generating the plurality of frames by detecting sketch images of time points determined in accordance with a preset criterion.

16. The method of claim 15, wherein the generating of the plurality of frames comprises calculating a value (A) by dividing a time required for completing the sketch image by a preset value and detecting each of sketch images of time points that are A*N (N=1, 2, 3, . . . , and the preset value) after drawing of the sketch image is started, to generate the plurality of frames.

17. The method of claim 15, wherein the generating of the plurality of frames comprises calculating a value (B) by dividing a total number of strokes constituting the sketch image by a preset value and detecting each of sketch images of time points when (B*N)^{th} (N=1, 2, 3, . . . , and the preset value) strokes are completed, to generate the plurality of frames.

18. The method of claim 15, wherein the generating of the plurality of frames comprises calculating a value (C) by dividing a total number of points constituting the sketch image by a preset value and detecting each of sketch images of time points when (C*N)^{th} (N=1, 2, 3, . . . , and the preset value) points are completed, to generate the plurality of frames.

19. The method of claim 13, further comprising generating new frames by augmenting the plurality of frames; and
extracting features from each of the new frames,
wherein the training of the deep learning model comprises training the deep learning model on the basis of the features extracted from each of the new frames and the features extracted from each of the existing frames.

20. The method of claim 19, wherein the generating of the new frames comprises augmenting the frames by performing, on any frame, at least one of an operation of rotating at least one stroke, an operation of changing a generation turn of at least one stroke, an operation of changing a shape of at least one stroke, and an operation of changing a ratio of at least one stroke.
